(19) United States
(12) Patent Application Publication
(10) Pub. No.: US 2008/0181123 A1
(43) Pub. Date: Jul. 31, 2008

(54) METHODS AND APPARATUS TO MANAGE NETWORK TESTING PROCEDURES

(76) Inventors: Alexander Lisheng Huang, Austin, TX (US); Chaoxin Charles Qiu, Austin, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/669,770

(22) Filed: Jan. 31, 2007

(51) Int. Cl. H04J 1/16

(52) U.S. Cl. 370/252; 370/465

(57) ABSTRACT

Methods and apparatus are disclosed to enable packet telephony performance testing. An example method disclosed herein includes receiving a request to execute a test, and obtaining a testing rule associated with the requested test, the testing rule including a test parameter threshold. The example method also includes determining a compliance status between the test parameter threshold and the request to execute the test, and allowing or denying execution of the test based on the compliance status.

### FIELD OF THE DISCLOSURE

This disclosure relates generally to packet telephony over packet-switched networks, and, more particularly, to methods and apparatus to manage network testing procedures.

### BACKGROUND

Voice over Internet protocol (VoIP) telephone systems may offer many additional feature-related benefits over traditional public-switched telephony networks (PSTN), For example, a VoIP phone user may travel with a VoIP-enabled phone while on vacation and/or business and receive/place calls from anywhere in the world as if they were located in their home or office, provided Internet access is available. Callers need not be concerned with the user's global location, but can simply dial the same telephone number (e.g., a ten-digit number) to reach the user irrespective of the physical location of the user's phone. Additionally, VoIP systems are being employed in increasing numbers due to, in part, significant cost benefits over traditional PSTN networks.

VoIP telephone systems typically rely upon a fast transmission control protocol (TCP)/internet protocol (IP) network (e.g., Internet) connection and require a VoIP telephone service provider that maintains, among other things, a call-control server to facilitate phone number/Internet protocol translation services. Prior to a user's telephone call attempt reaching the service provider's call-control server, or any other equipment maintained and/or operated by the service provider, the user must rely upon network infrastructure beyond the control of the service provider. For example, the VoIP user may connect to an intranet of a hotel complex having one or more network elements (NEs), such as one or more routers, hubs, and/or wireless access points (WAPs). Each of the various NEs may have a fixed latency and/or a variable latency based on, for example, hotel occupancy demands on the intranet. Additionally, the example hotel intranet may obtain Internet access for hotel guests by virtue of a third-party network service provider such as an Internet Service Provider (ISP), which also maintains and operates various NEs that may exhibit latency effects and/or other network performance variations. Accordingly, before the VoIP user's call attempt traverses the Internet to reach the VoIP service provider's NEs (e.g., the call-control server), various network delays and/or network performance anomalies may occur.

Similar network delays and/or network performance anomalies may also occur within the VoIP service provider and/or network operator network(s). As such, the VoIP service provider may attempt to configure and/or build the network(s) and various NEs to minimize such negative performance experiences by the VoIP customers. To this end, the VoIP service provider typically performs a variety of tests on the network and NEs in an effort to maintain awareness of overall network health. Knowledge of network performance characteristics (i.e., network health) allows network administrators an opportunity to address potential problems before they manifest themselves as a negative experience by the VoIP customers and/or other users of the network(s).

### BRIEF DESCRIPTION OF THE DRAWINGS

FIG. 1 is a schematic diagram illustrating an example system to manage network testing procedures.

FIG. 2 is a more detailed illustration of the example test rule manager of FIG. 1.

FIGS. 3 and 4 are example graphical user interfaces (GUIs) for the example system of FIG. 1.

FIGS. 5-7 are flow diagrams representative of example machine readable instructions which may be executed to implement the example system of FIG. 1.

FIG. 8 is a schematic diagram illustrating another example system to manage network testing procedures.

FIG. 9 is a more detailed illustration of the example rule processor of FIG. 8.

FIGS. 10-12 are flow diagrams representative of example machine readable instructions which may be executed to implement the example system of FIG. 8.

FIG. 13 is a schematic illustration of an example computer that may execute the example instructions of FIGS. 5-7 and 10-12 to implement the example systems of FIGS. 1 and 8.

### DETAILED DESCRIPTION

Methods and apparatus are disclosed to enable packet telephony performance testing. An example method includes receiving a request to execute a test, obtaining a testing rule associated with the requested test, the testing rule including a test parameter threshold, and obtaining a network value representative of a network condition. The example method also includes determining a compliance status between the test parameter threshold and the network value, and allowing or denying execution of the test based on the compliance status.

Network testing allows network engineers to determine a health status of a network. The network may include a wide variety of network elements (NEs), such as hubs, routers, modems, and/or various types of servers. Because of the autonomy of routers that comprise a packet network, independent routing of individual packets and random network traffic distribution may result in variations of voice quality for voice over Internet protocol (VoIP) services. Such variation may occur intermittently and/or at periodic intervals. Additionally, observed performance characteristics of a portion of the network are not necessarily indicative of voice quality over the network as a whole, thereby placing added importance on continuous end-to-end voice quality testing/monitoring.

Voice quality experienced by one or more users may depend on the performance of end-to-end network transport of voice packets and the performance of VoIP terminal equipment at both ends of a call. As such, the VoIP terminal equipment is a particularly useful point for adding functions to collect data for network management and resolve troubling issues related to voice quality. The service provider and/or the users, with an increasing trend of such owners being the users, may own VoIP terminal equipment. When such terminal equipment is used to help determine network performance and/or identify voice quality issues, testing procedures that utilize the terminal equipment may be in conflict with the privileges and activities of the users.

Such testing is particularly advantageous because it may allow the network engineer to identify potential network anomalies before they have an adverse effect on customers using the network. Network anomalies may include, but are not limited to, static network traffic delays, dynamic/varied packet delays (i.e., jitter), and/or an occurrence of dropped packets. These network anomalies are particularly troublesome for networks that support VoIP services to a customer base. Delays, losses, and/or jitter may degrade the quality of voices transmitted in the network by producing effects, such as, for example, poor clarity, double-talk, and/or lost voice data.

Testing live production VoIP networks on a continuous and/or periodic basis is also warranted in view of added network complexities for at least three types of calls that VoIP service providers support. A first type of VoIP call may include a VoIP caller to a VoIP callee within the same network, such as two VoIP customers of the same VoIP service provider. Such calls may include a trusted call-control server owned and operated by the VoIP service provider to facilitate Internet protocol (IP) routing and/or phone number resolution between the caller and the callee.

A second type of VoIP call includes a VoIP caller on one network to a VoIP callee on a separate network. The separate network may, or may not be owned/operated by the VoIP caller's service provider. Data transmission/receipt between these networks may have to traverse greater distances, and/or traverse through additional NEs not necessarily within the control of either the caller or callee's VoIP service provider. Additional latency durations may result from calls of this type. Therefore, testing between the caller and a demarcation point of the two networks is helpful to identify which network is mainly responsible for certain end-to-end performance issues.

A third type of VoIP call may include a VoIP caller (or callee) and a circuit-based (e.g., a PSTN) callee (or caller). Additional NEs are typically employed to allow packet-based telephone communications to reach a circuit-switched telephone network, such as an IP-PSTN gateway. These additional NEs may add additional latency, jitter, and loss of the data transmissions.

In view of the aforementioned example types of calls that VoIP service providers support, test and measurement (T&M) equipment may be employed to determine network conditions. Such equipment may include, but is not limited to oscilloscopes, spectrum analyzers, network analyzers, logic analyzers, protocol analyzers/exercisers, bit error ratio (BER) testers, and/or signal generators. Data derived from the T&M equipment may be indicative of, but not limited to, transmission rates (e.g., up-direction bit rate(s), down-direction bit rate(s), etc.), signal power level(s), signal power spectral densities, signal-to-noise ratio information, jitter characteristics, transmission frequencies, eye-diagrams (e.g., bitmap, JPEG, etc.) and/or eye-diagram parameters (e.g., eye-width, eye-height, eye-jitter, eye-mask violation(s), etc.),

To measure various network parameters, the network engineer may employ one or more dedicated VoIP terminal equipment devices (e.g., VoIP-enabled phones, VoIP-to-analog-telephone adaptors, aka ATA, etc.) to send sample test calls from an originating point to a destination point. However, inserting numerous dedicated terminal equipment devices at exactly such destination point may be technically very difficult and is not economically practical. However, the VoIP service provider may reduce costs by employing users' VoIP-enabled phones or ATAs and, instead, employ a call-control server to initiate testing between network points (e.g., between phones). In such a scenario, the telephones do not initiate the setup protocol sequence, but merely respond to the protocol sequence(s) initiated by the call-control server(s), thereby minimizing the complexity of the testing function(s) and cost. Test endpoints (e.g., originating and/or destination points) may also include test responders. The test responders may include custom built and/or off-the-shelf devices to be placed at network demarcation points when testing the network(s). Test responders behave similarly as the VoIP-enabled phones with testing functions, but are owned and/or operated by the network operator. Such lest responders are typically located at network-to-network demarcation points. Additionally, the network engineer may perform such sample test calls at various times of the day to ascertain bandwidth limitation trends. However, employing network telephone devices for the purpose of deriving useful network performance data further burdens a network that may already be overburdened and/or otherwise not performing in a manner suitable for VoIP customers.

Test calls may be manually initiated by network administrators/engineers and/or occur automatically on a continuous, periodic, and/or pseudo-periodic basis. Test calls may also be manually initiated by VoIP service subscribers on a restricted basis in scale and/or depth, thereby potentially reducing the time of trouble resolution while saving the cost of the support providers. As discussed in further detail below, the test calls may be configured and/or initiated via a user interface portal, such as a web page. Test call sequences may be initiated to send and/or receive test data between telephones and/or between a telephone and the test responder(s) located at various points (demarcation points) of the network. Signaling protocols used for such test calls may include, but are not limited to, Session Initiation Protocol (SIP) specified by the Internet Engineering Task Force. An example call-control server SIP-based method is INVITE, which invites a client to participate in a call session. Once a test call is set-up and initiated, the T&M equipment may observe terminating and/or passing packet streams and collect data indicative of network health. However, to minimize the potentially adverse effects of consuming bandwidth by initiating testing when bandwidth resources and/or terminal equipment resources are already low (e.g., conflicts between the testing activity and the users' privilege and activity), various rules (e.g., guarding rules) may be invoked to determine a compliance status and dictate when testing procedures may occur.

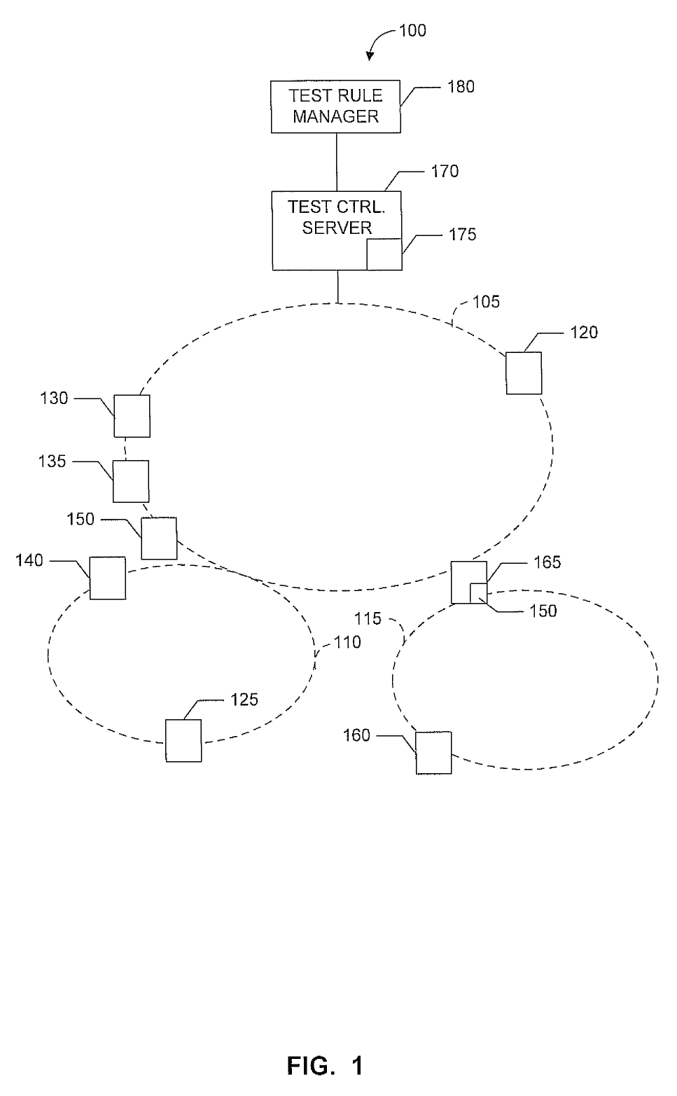

An example system 100 to manage network testing procedures is shown in FIG. 1. The system of FIG. 1 illustrates how the present system may be helpful to a network operator in certain calls of which the paths only partially reside in its own network, in which alternate paths reside in other packet or circuit networks operated by other operators. The example system 100 of FIG. 1 includes a first example packet-switched network 105, a second example packet-switched network 110, and an example circuit-switched (e.g., PSTN) network 115. In the illustrated example of FIG. 1, only network 105 and its operator is equipped with the testing management method and system proposed in the present system. The first example packet-switched network 105 includes an example call control server 120 that may operate to, in part, perform address translation, routing, and/or device authentication on the network 105. The first packet-switched network 105 includes a network of VoIP enabled phones, two of which are illustrated in FIG. 1 as a first VoIP-enabled phone 130 and a second VoIP-enabled phone 135. Similarly, the second packet-switched network 110 includes a network of VoIP enabled phones, one of which is illustrated in FIG. 1 as a third VoIP-enabled phone 140. The first example packet-switched networks 105 also includes a test responder 150. Generally speaking, any of the VoIP-enabled phones (130, 135, 140) may include specialized testing protocols and/or testing capabilities. However, the example system 100 allows less feature-rich VoIP-enabled phones, which do not include such specialized testing functionality to participate in testing methodologies, thereby facilitating a more cost-judicious testing environment.

In the illustrated example circuit-switched network 115 of FIG. 1, an example circuit-based telephone 160 is communicatively connected to a packet to circuit network gateway 165. The example packet to circuit network gateway 165 facilitates, in part, communication junctions between circuit-based (e.g., public-switched telephony network (PSTN)) and packet-based networks. Typically, a user of a circuit-based communication device (e.g., a telephone) may not realize that communication is taking place on a packet-based network and/or with a packet-based communication device (e.g., a VoIP-enabled telephone). The example packet to circuit network gateway 165 of FIG. 1 includes a test responder 150.

Persons of ordinary skill in the art will appreciate that communication devices, such as the example VoIP-enabled telephones (130, 135, 140) and the example circuit-based telephone 160, may place and/or receive calls over the example packet-switched networks 105, 110 and/or the example circuit-switched network 115. In the illustrated example of FIG. 1, the first example network 105 is communicatively connected to a test control server 170 to facilitate device and/or NE testing. However, the second example packet network 110 and the circuit based network 115 of FIG. 1 are third party owned and/or operated. As such, an operator of the first example packet-switched network 105 does not have access to any facilities of third party and/or foreign networks. In the illustrated example, requests for network device and/or NE testing initiated by the test control server 170 result in consumption of a portion of available network bandwidth on the first example packet network 105. For example, the test control server 170 may initiate a request to the call control server 120 of the first example packet network 105. As a result, the call control server 120 invokes the VoIP-enabled phone 130 to send sample data to a destination point, such as, for example, the second VoIP-enabled phone 135. As the test data is exchanged between the test points, which in this example are the first 130 and second 135 VoIP-enabled telephones, T&M equipment 175 may perform empirical tests and/or measurements on the networks and/or monitor the exchange(s) for various performance parameters, such as up-direction bit rate.

While the T&M equipment 175 is shown within the test control server 170, persons or ordinary skill in the art will appreciate that the T&M equipment 175 may be located in and/or throughout the example network 105 and/or within a central office (CO). Without limitation, the T&M equipment 175 may be located in multiple locations of the example network 105 to acquire data for geographically separated networks at the same time. As discussed above, network health maybe ascertained in view of network transmission rates (e.g., down-direction bit rate(s), up-direction bit rate(s)), signal power level(s), signal power spectral densities, signal-to-noise ratio information, jitter characteristics, transmission frequencies, eye-diagrams, and/or occurrences of eye-diagram mask violation(s). As described above, the T&M equipment 175 may include, but is not limited to, oscilloscopes, spectrum analyzers, network analyzers, logic analyzers, protocol analyzers/exercisers, bit error ratio (BER) testers, and/or signal generators. The T&M equipment 175 may operate on a continuous, periodic, and/or random basis to acquire and store network performance parameters. Such measurements may be stored in a memory of the test control server 170, a test rule manager 180 (discussed in further detail below), and/or any other memory.

Persons of ordinary skill in the art will appreciate that a service provider may only have access to one network. For example, if a first service provider owns, controls, and/or manages the first VoIP network 105, the first service provider typically has no right or ability to access the second VoIP network 110 that may be owned by a second service provider. As such, the first service provider will only have access to testing procedures for the first VoIP network 105. A call may involve multiple networks, such as a call placed between telephones 130 and 140, or between 130 and 160. For assuring and/or disputing performance of such multiple-network calls, it is important to the operator of the first VoIP network 105 that it have performance measurements for the portion of such calls within its own network 105 up to the demarcation point. This may be done by conducting test calls between one telephone (e.g., 130) and one test responder (e.g., 150). The benefit is that if a performance problem is found in such test calls, the responsibility of solving the problem lies with the operator of first VoIP network 105. On the other hand, if a performance problem is not found in such test calls, then the responsibility lies with the operator of other network(s) such as 110 or 115.

However, while data acquired by the test control server 170 may be useful to a network administrator, network engineer, service provider, and/or customer in determining network health and/or performance issues, test requests by the test control server 170 typically result in additional bandwidth utilization and resource utilization internal to network-owned test call responders. A network that is overburdened with a heavy demand may exhibit sub-standard performance and anger subscribers (e.g., VoIP telephone users). Invoking network tests during these heavy demand times may exacerbate such performance issues and, thus, be counter-productive. To alleviate this issue, the T&M equipment 175 may periodically gather the amount of available network bandwidth and store the recorded value(s) to the memory, which is accessible by the test rule manager 180. Before permitting a test procedure to execute, the test rule manager 180 may compare the measured parameter to a threshold value. If the amount of available network bandwidth for a segment of the network is low (i.e., an amount of available network bandwidth is less than a particular threshold value), then the rule may disallow the test procedure, which would affect such network segment, from executing in an effort to preserve call quality and bandwidth for the subscribers. In this manner, the T&M equipment can adapt its measurements to times that will not noticeably degrade network performance. Additionally or alternatively, the test rule manager 180 may permit and/or prohibit a lest from executing based on a test permission flag and/or a test denial flag for any particular VoIP-enabled phone, IP address, and/or range of IP addresses.

In addition to performance-related concerns for testing networks at inappropriate times, security concerns may arise from the ability of the test control server to invoke services of communication devices on the example network 105. For example, persons of ordinary skill in the art will appreciate that VoIP-enabled telephones (130, 135) are typically configured to respond only to a trusted call control server. The communication devices (e.g., VoIP phones) are securely associated to the call control servers to minimize unauthorized services from being consumed by illegitimate parties. Any service request by any other party is, thus, ignored.

To address both the performance and security issues described above, the example system 100 of FIG. 1 includes a test rule manager 180. In the illustrated example, the test rule manager 180 minimizes and/or eliminates negative performance effects associated with test invocation by allowing the user to design and/or implement specific rules that dictate when tests may occur on the various networks, such as the first network 105. Additionally, the example test rule manager 180 minimizes and/or eliminates security related issues associated with test invocation by constraining the frequency, the duration of test calls per unit of time, and/or which call control servers may be accessed, as discussed in further detail below. Generally speaking, the test rule manager 180 may determine current and/or anticipated bandwidth consumption levels of the network and compare such levels against a predetermined threshold. For example, if the first packet-switched network 105 has 10% of its available bandwidth remaining, the example rule of the test rule manager 180 may prohibit testing in an effort to spare effective bandwidth for subscribers during these heavy use times. Additionally, or alternatively, another example rule of the test rule manager 180 may limit all test calls to 7-seconds. As such, even if a portal for the customer is utilized by a hacker to request and abuse test calls, the hacker will have no more than 7-seconds of access before the services are terminated. Other security constraints that may be imposed by the test rule manager 180 include maintaining a list of authorized NEs, such as call control servers and/or gateways. As a result, the test rule manager 180 may deny test requests that attempt to utilize unauthorized NEs.

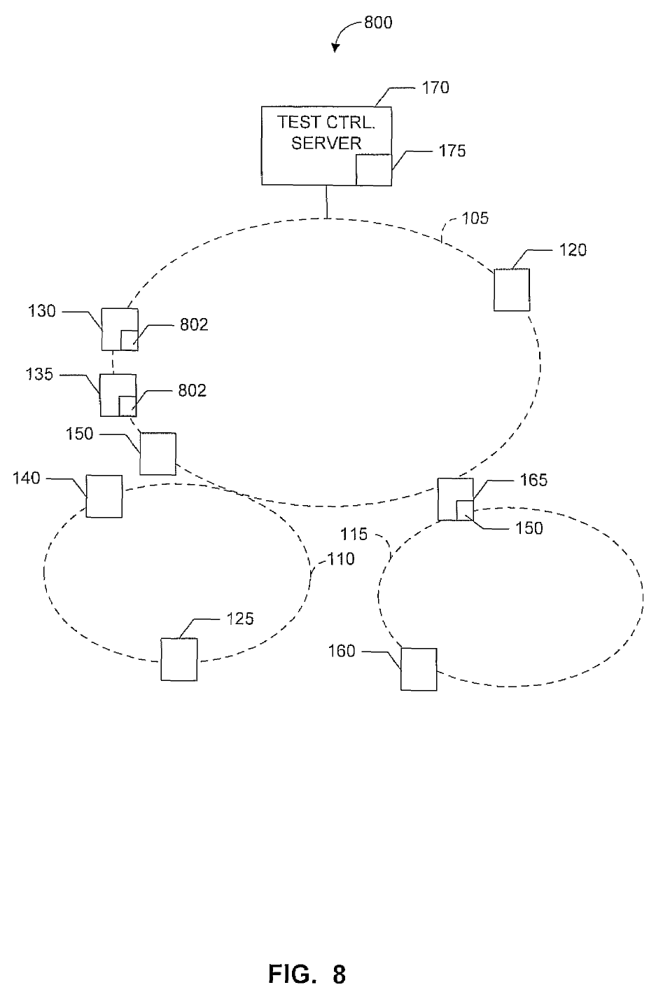

While the example system 100 shown in FIG. 1 includes the test rule manager 180 to, among other things, manage testing activity, testing management may also be accomplished without the test rule manager 180. As discussed in further detail below in view of FIG. 8, test management (e.g., authorization and/or denial of testing procedures) may be controlled by the VoIP-enabled phones of the network(s) (e.g., the first VoIP phone 130, and/or the second VoIP phone 135).

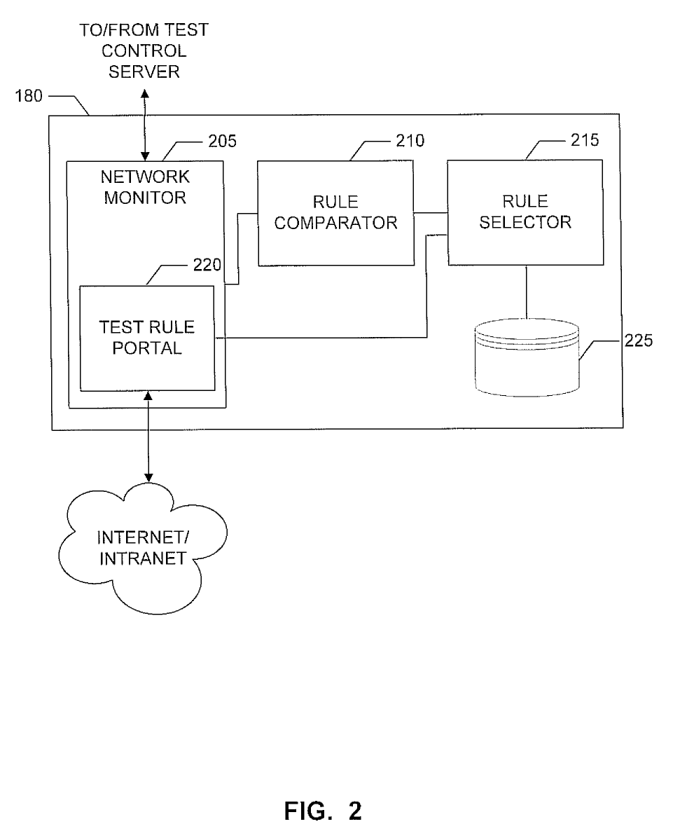

An example test rule manager 180 is shown in FIG. 2. The example test rule manager 180 includes a network monitor 205, a rule comparator 210, a rule selector 215, a test rule portal 220, and a data source 225. In the illustrated example, the network monitor 205 is communicatively connected to the test control server 170. User interaction and/or access to the test rule manager 180 may be accomplished via the Internet/intranet, and/or via computer, workstation, kiosk, etc. In the illustrated example, the network monitor 205 enables communication via web-pages via the test rule portal 220, which operates as a web server and/or graphical and/or command-line user interface. The network monitor 205 also communicates with the test control server 170 to facilitate network test procedures and/or network data acquisition to determine the health status of the network(s). As discussed below, rules may be invoked by the test rule manager 180 via the network monitor 205 to initiate testing procedures and/or operate the T&M equipment 175.

Prior to allowing a network testing procedure to execute, the example rule comparator 210 determines whether a selected rule results in an approval or denial of a test. As discussed in further detail below, the rule comparator compares rule constraint(s) (e.g., one or more threshold values) against one or more test request(s). The testing parameters of the illustrated example include, for example, which networks will be affected by the testing procedure(s), expected testing bandwidth needed by the testing procedure(s), a testing frequency (e.g., a number of send/receive iterations per unit of time), specific endpoints to be tested, a media type (e.g., voice test packets, video test packets, etc.), a codec type, and/or specific IP addresses to be used in the requested testing procedure(s). In the illustrated example, rule constraints include a currently available network bandwidth (maximum, minimum), number of tests per unit of time (e.g., a limit of 16 test calls per day), a date range to allow/deny tests, a time range to allow/deny tests, an IP address range, and/or a test duration. Some or all of the above testing parameters and/or rule constraints may be eliminated, combined, and/or replaced with other parameters and/or constraints.

Generally speaking, any type of rule constraint may be employed to ensure that network testing procedures do not significantly negatively affect network subscribers. The rule constraints may promote call preservation efforts by making sure current calls are not dropped as a result of network resource demands imposed by one or more testing procedures. Additionally, the rule constraints may control an existing call quality level by prohibiting the execution of testing procedures that would negatively impact current call quality.

The example constraints may also be applied to any desired location (e.g., to all available networks, to specific networks, to particular sub-networks, to particular area code(s), and/or to particular central office (CO) prefix values.). For example, the rule may identify an available bandwidth constraint and a threshold of “greater than 25%.” Additionally, the rule may specify that, if the threshold is exceeded, then a network test may proceed. Moreover, this rule may be applied to all networks, one or more specific networks, one or more specific area codes, one or more specific CO prefix values, and/or one or more specific IP address ranges.

In the illustrated example, the user may select a rule and/or set(s) of rules via the test rule portal 220. The test rule portal may be a web server for the user (e.g., a consumer, a network administrator/engineer, a service provider network technician, etc.) to access the rule selector 215. Activities accomplished by the user of the test rule portal 220 may include, but are not limited to, selecting one or more rules, designing a rule, creating one or more profiles of rules, activating/deactivating one or more profiles, and/or editing rule constraints. The rule selector 215 may operate as a database engine to query information stored in the data store 225. Information stored in the data store 225 may include, but is not limited to, one or more rules and/or one or more profiles that represent one or more sets of rules. Persons of ordinary skill in the art will appreciate that various types of database engines may be employed. For example, a structured query language (SQL) may be used to retrieve and/or save information from/to the data store 225. The test rule portal 220 may be designed to provide a front-end graphical user interface (GUI) for the user and generate dynamic SQL commands to search for, receive, and/or store information from/to the data store 225.

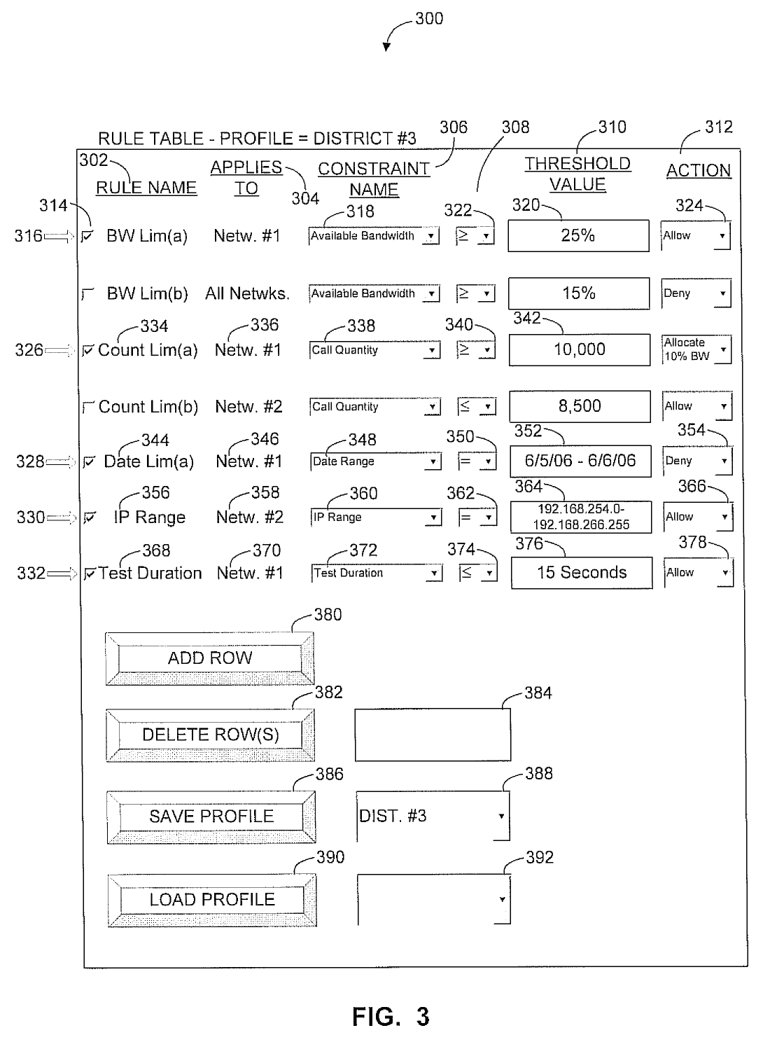

FIG. 3 is an example GUI rule table 300, which, in the example of FIGS. 1 and 2, is displayed by the test rule portal 220. The illustrated example GUI rule table 300 includes a variety of rows, each of which defines a rule to be evaluated prior to allowing a network test to proceed. Each example rule includes a rule name column 302 and a column to identify rule application 304. For example, the user may specify that any particular rule applies to only a specific network, to a specific sub-network, and/or to all networks. Each example rule also includes a constraint name column 306, a comparator instruction column 308, a threshold value column 310, and an action column 312. Additionally, each example rule may be activated or deactivated with an activation check-box 314.

In the illustrated example, the constraint name column 306 includes a drop down menu in each row to allow the user to select a constraint. Constraints selected by the user may include parameters that identify a tangible value and/or may be measured by the example T&M equipment 175. For example, constraints may include, but are not limited to, a bandwidth capacity, a network call quantity (e.g., a tally/count of the number of subscriber calls presently being supported by the network(s)), a date range, a time of day range, an IP address, a range of IP addresses, a test quantity (e.g., a tally/count of the number of tests performed on the network(s) per unit of time), and/or a test duration. Each of the constraints may serve as a comparison to the threshold value 310, which the user may select via a drop-down box. Persons of ordinary skill in the art will appreciate that, instead of, or in addition to a drop-down box, a data entry field may be provided as shown in FIG. 3 to allow the user to enter a specific value.

Threshold values selected and/or entered by the user are compared to the selected constraint in a manner consistent with the selected comparator instruction 308. In the illustrated example of FIG. 3, comparator instructions include “greater-than-or-equal-to” (≧), “less-than-or-equal-to” (≦), and “equal” (=). When the values associated with the constraint name 306 and the threshold value 310 are compared to each other in view of the selected comparator instruction 308, then a true condition results in execution of the instruction listed in the action column 312. For example, a first rule (row 316) includes “Available Bandwidth” 318 as the constraint, “25%” 320 as the threshold value, and “greater-than-or-equal-to” 322 as the comparator instruction. Based on measurements taken by the T&M equipment, the test control server 170 determines various network parameter values before initiating any tests such as, for example, bandwidth consumption. If the available bandwidth for the first example packet-switched network 105 is greater than or equal to 25%, then the action column 312 indicates a test request may be allowed 324. However, the network testing procedures are not permitted unless all of the various active rules are satisfied. Generally speaking, the active rules (i.e., those having a check-mark in the corresponding activation check-box 314) operate as a logical AND condition. Therefore, despite the first rule (row 316) being satisfied, several additional rows having a check-marking in the corresponding activation check-boxes 314 must also be satisfied to prevent testing. More specifically, rows 326, 328, 330, and 332 must be satisfied, as discussed in further detail below.

Example row 326 includes a rule name of “Count Lim(a)” to be applied to “Netw. #1” 336 (i.e., the first example packet-switched network 105). The example rule of row 326 includes a constraint name of “Call Quantity” 338 that must be “greater-than-or-equal-to” 340 a value or “10,000” 342 before the corresponding action column 312 instruction is executed. In the illustrated example, if the number of simultaneous calls being supported by all networks exceeds a count of 10,000, then the test may only proceed if an additional 10% of bandwidth is allocated to the first example packet-switched network 105. Persons of ordinary skill in the art will appreciate that the service provider, network engineer, and/or network technician may need to implement additional and/or alternative network equipment and/or NEs to allocate additional bandwidth.

Example row 328 includes a rule name of “Date Lim” 344 to be applied to “Netw. #1” 346. The example rule of row 328 includes a constraint name of “Date Range” 348 that must be “equal to” (350) a range of Jun. 5, 2006 through Jun. 6, 2006 (352) before the corresponding action column 312 instruction “Deny” 354 is executed. As a result, the example rule of row 328 disallows any test between the listed dates for the first example packet-switched network 105, but does not necessarily restrict test procedures for other network(s) (e.g., the second example packet-switched network 110, the example circuit-based network 115, etc.).

Example row 330 includes a rule name of “IP Range” 356 to be applied to “Netw. #2” 358 (i.e., the second example packet-switched network 110). Persons having ordinary skill in the art will appreciate that the example system 100 may include one or more networks under the ownership and/or control of the user. As such, the example test rule manager 180 may control one or more test procedures of other networks, such as the example second packet-switched network 110 in the event that it is owned and/or operated by the user. The example rule of row 330 includes a constraint name of “IP Range” 360 that must be “equal to” (362) a range of 192.168.254.0 through 192.168.255.255 (364) before the corresponding action column 312 instruction “Deny” 366 is executed. As a result, the example rule of row 330 disallows any test for the identified IP address range, but does not necessarily restrict test procedures for other IP address ranges. Furthermore, the example rule of row 330 applies only to the second example packet-switched network 110. Thus, if the identified IP range is or becomes associated with, for example, the first example packet-switched network 105, then the rule of row 330 will have no effect.

Example row 332 includes a rule name of “Test Duration” 368 to be applied to “Netw. #1” 370. The example rule of row 332 includes a constraint name of “Test Duration” 372 that must be “less-than-or-equal-to” (374) “15 seconds” (376) before the corresponding action column 312 instruction “Allow” 378 is executed. As a result, test procedures designed by network engineers, network technicians, and/or service providers that operate for more than 15 seconds will not be granted permission to execute. Reasons for implementing test duration constraints may include, but are not limited to, an interest by the service provider to minimizing resource competition and maximize subscriber service performance.

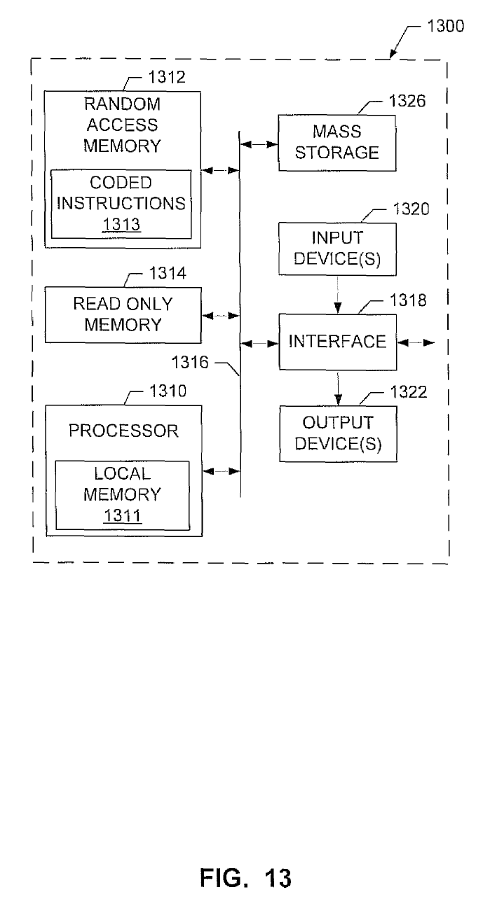

In operation, a user enters values into the example rule table 300. The values in the table are retained by the example test control server 170 via the network monitor 205 prior to executing test procedures on network resources. In the illustrated example, comparisons between constraints 306 and thresholds 310 may be performed by the example rule comparator 210, which may include processing resources, such as those described in view of FIG. 13 below. If the available bandwidth of the first example packet-switched network 105 is greater than 25% (i.e., the example rule in row 316), and if an additional 10% network bandwidth is allocated (i.e., the example rule in row 326), and the current date does not fall between Jun. 5-6, 2006 (i.e., the example rule in row 328), and the IP range to be tested is not between 192.168.254.0 through 192.168.255.255 (i.e., the example rule in row 330), and the duration of the requested test procedure is less than or equal to 15 seconds (i.e., the example rule in row 332), then the requested test procedure may execute. Persons of ordinary skill in the art will appreciate that the GUI of FIG. 3 should not be construed as limiting. For example, the GUI 300 may include logical AND and/or OR operators in between the rows to further dictate rule behavior.

In the event that the user(s) needs additional rules for analysis of whether to allow a test procedure to execute, an “Add. Row” button 380 may be selected, which causes the GUI 300 to add an additional row. Persons of ordinary skill in the art will appreciate that new rows may be added to the example GUI 300 in a default state, such as, for example, a new row that is deactivated by default. The user(s) may subsequently configure the new row(s) in view of desired network performance and/or testing requirements, as described above. Additionally, in the event that the user(s) needs to eliminate rules from the example GUI 300, a “Delete Row(s)” button 382 may be selected. Persons of ordinary skill in the art will appreciate that rows may be selected for deletion in any number of ways including, but not limited to, by entering row numbers in a text box 384 and/or by selecting one or more rows with a mouse and/or other pointing device.

In some instances, the user (e.g., the service provider, network engineer, network technician, etc.) maybe responsible for several networks and/or sub-networks. As such, a single set of rules may be too limiting to reflect testing procedure management for all of the networks. In the event that the user wants to configure more than one set of rules to be applied to test procedure execution analysis, the user(s) may select a save profile button 386 after labeling a set of rules with a name in an entry field 388. In the illustrated example, the GUI 300 represents a profile named “District #3”. Similarly, in the event that the user wants to review a previously saved profile for review and/or editing, a load profile button 390 may be selected after choosing a saved profile from an entry field 392. While the example GUI 300 illustrated in FIG. 3 shows the various rows/rules being applied to a non-homogeneous list of networks (e.g., both “Netw. #1,” “Netw. #2,” and “All Nelw.”), persons of ordinary skill in the art will appreciate that one or more profiles may be configured by the user to apply to a single network (e.g., rules that only apply to “Netw. #1”) and/or sub-network in an effort to simplify test procedure rule management.

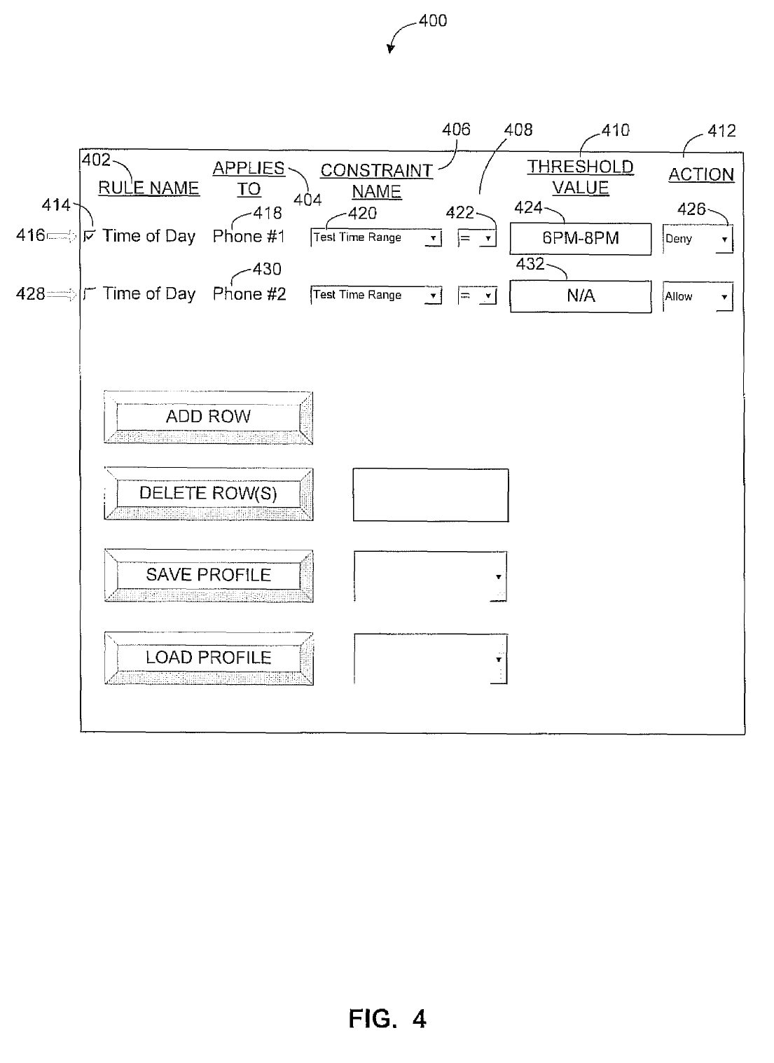

FIG. 4 is an example GUI rule table 400 displayed by the test rule portal 220 to facilitate entry of data to enable subscriber control over test procedure authorization. The illustrated example GUI rule table 400 includes a variety of rows/rules similar to those discussed in view of the example GUI rule table 300 of FIG. 3. However, a service provider may scale-down the amount of control a subscriber has over test procedure authorization that utilizes the subscriber's communication devices (e.g., VoIP telephones). As described above, test procedures may utilize non-specialized VoIP telephone equipment (e.g., “standard” VoIP telephones) to perform network testing in a more economical manner versus employing a plurality of specialized VoIP telephone equipment in subscriber homes. Although remotely invoking the subscriber's VoIP telephone equipment may provide useful network performance data to the service provider, if performed under the wrong conditions, such testing may result in degraded performance to the subscriber's network communication capabilities. Degraded performance of the subscriber's network may manifest itself in several ways including, but not limited to, reduced voice quality, broken voice transmission and/or reception due to lost packets, and/or slower network performance due to increased bandwidth consumption as a result of test procedures. The increased bandwidth consumption required by the testing procedures may also have an adverse effect on the speed of the subscriber's household Internet connectivity.

In the event that subscribers have some degree of control over when testing procedures are performed and/or which test(s) may utilize household VoIP telephone equipment, the service provider may permit the subscriber to exercise such control by entering data via a web page facilitated by the test rule portal 220. The test rule portal 220 may employ authentication procedures prior to allowing web-based connection access. Example authentication credentials provided by the service provider (to the subscriber) permit subscriber access to the example GUI 400 rather than the example GUI 300 of FIG. 3. The example GUI 400 of FIG. 4 includes a layout similar to that of the example GUI 300 or FIG. 3, which includes a rule name column 402, a column to identify rule application (“Applies To”) 404, a constraint name column 406, a comparator instruction column 408, a threshold value column 410, and an action column 412. In particular, the example GUI 400 of FIG. 4 limits subscriber control of testing procedures to dates and/or times at which one or more tests may execute.

For example, the subscriber may configure the example GUI 400 to prohibit test procedures from executing during hours at which the subscriber is likely to prefer maximum bandwidth. Such hours of the day may include, but are not limited to, evening hours when household family members have returned from work and/or school and require a relatively high at-home network bandwidth to accommodate telephone calls and/or maximum internet connectivity speed. To effectuate limitations on when a testing procedure may execute, the subscriber may activate a rule activation check-box 414, such as the rule activation check-box in example row 416. Additionally, because the subscriber may have multiple VoIP communication devices within the example household, one rule/row may be listed in the example GUI 400 for each VoIP telephone. In the illustrated example, rule/row 416 applies a constraint name “Test Time Range” (420) to “Phone #1” (418), and a comparator instruction of “equal to” (422). Example rule/row 416 also includes a subscriber-editable entry field 424 in which the subscriber may enter a range of times, and an action selection drop-down menu 426 for which the subscriber may select a corresponding action. In operation, the example rule of row 416 prohibits any network testing that utilizes “Phone #1” (418) between the hours of 6:00 PM through 8:00 PM.

Also shown in the example GUI 400 of FIG. 4 is a rule/row 428 that applies to “Phone #2” (430) of the example household. The subscriber may not, for example, utilize the second phone 430 to the same degree each evening versus the first phone 418. As a result, the subscriber may select “N/A” (432) to indicate ‘not applicable’, thereby indicating no preference regarding when testing procedures are performed that utilize the second phone 430. Additionally, the service provider may employ an incentive program to reward the subscriber for permission to utilize one or more VoIP enabled communication devices within the household. For example, a subscriber may receive credits, discounts, and/or coupons in a manner proportionate to the amount of allowed test procedure time configured via the example GUI 400 of FIG. 4.

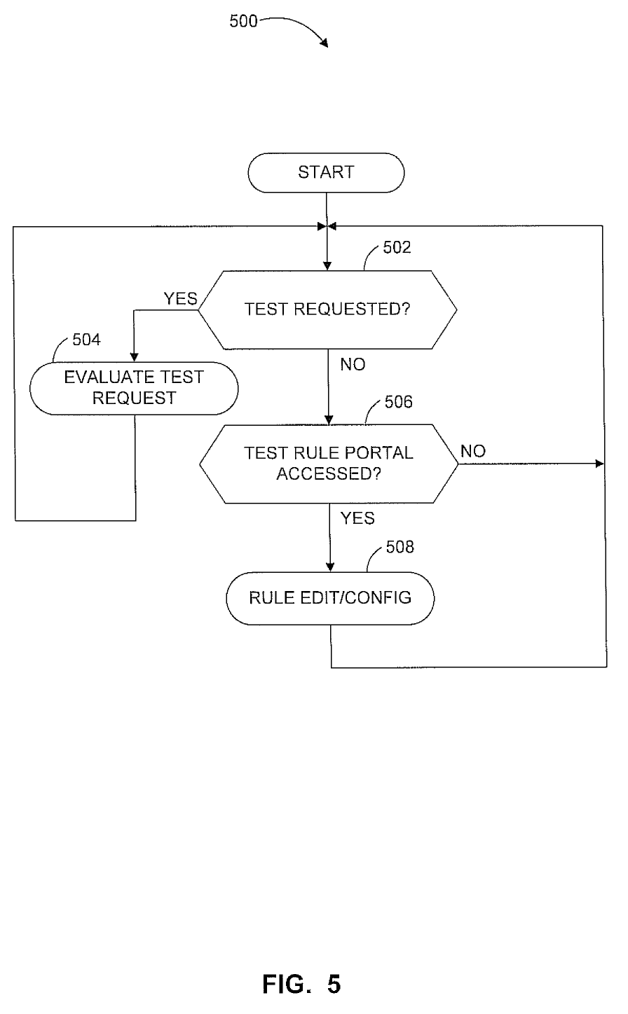

Flowcharts representative of example machine readable instructions for implementing methods and apparatus to manage network testing procedures are shown in FIGS. 5-7 and FIGS. 10-12. In this example, the machine readable instructions comprise a program for execution by: (a) a processor such as the processor 1310 shown in FIG. 13, which maybe part of a computer, (b) a controller, and/or (c) any other suitable processing device. The program may be embodied in software stored on a tangible medium such as, for example, a flash memory, a CD-ROM, a floppy disk, a hard drive, a digital versatile disk (DVD), or a memory associated with the processor 1210, but persons of ordinary skill in the art will readily appreciate that the entire program and/or parts thereof could alternatively be executed by a device other than the processor 1310 and/or embodied in firmware or dedicated hardware in a well known manner. For example, any or all of the example test rule manager 180, the network monitor 205, the test rule portal 220, the rule comparator 210, the rule selector 215, the first VoIP phone 130, the second VoIP phone 135, the phone rule processors 802 (discussed in further detail below), and/or the data store 225 could be implemented by software, hardware, and/or firmware (e.g., it may be implemented by an application specific integrated circuit (ASIC), a programmable logic device (PLD), a field programmable logic device (FPLD), discrete logic, etc.),

Also, some or all of the machine readable instructions represented by the flowcharts of FIGS. 5-7 and FIGS. 10-12 may be implemented manually. Further, although the example program is described with reference to the flowcharts illustrated in FIGS. 5-7 and FIGS. 10-12, persons of ordinary skill in the art will readily appreciate that many other methods of implementing the example machine readable instructions may alternatively be used. For example, the order of execution of the blocks may be changed, and/or some of the blocks described may be changed, substituted, eliminated, or combined.

The example process 500 of FIG. 5 begins at block 502 where the network monitor 205 of the example test rule manager 180 receives notification from the example test control server 170 that a test procedure is requested. If the example test control server 170 has issued a request for permission to execute one or more test procedures on a network(s), then the test rule manager 180 evaluates the test request (block 504), as discussed in further detail below. On the other hand, if no test request is received from the example test control server 170, then the example test rule manager 180 determines if a user attempts to access the web-based services of the example test rule portal 220 (block 506). If the user has requested access to the web-based services of the test rule portal 220, then the test rule portal 220 processes the user requests for rule review, editing, and/or other configuration procedures (block 508). On the other hand, if there is no user request for configuration services facilitated by the example test rule portal 220, the example process 500 of FIG. 5 returns to block 502. Persons having ordinary skill in the art will appreciate that blocks 504, 506, and/or 508 may operate in parallel.

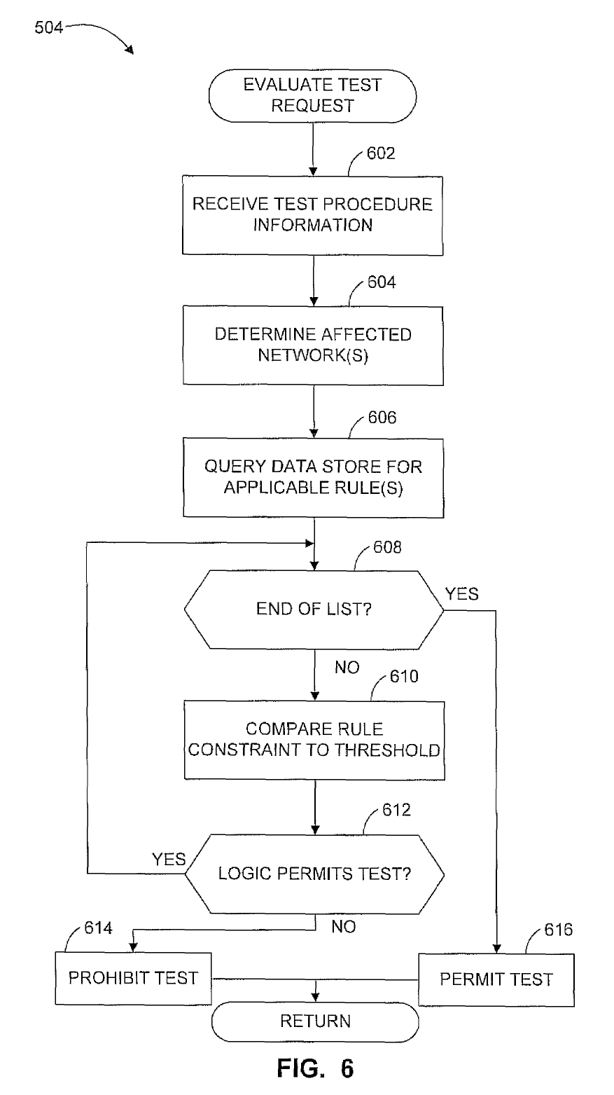

The example process to evaluate the test request (block 504) of FIG. 6 begins at block 602 where the network monitor 205 of the example test rule manager 180 receives testing procedure information from the example test control server 170. Information provided by the example test control server 170 may include, but is not limited to, network(s) upon which the requested test will execute, a duration of the network test (e.g., 14 seconds), a number of iterations of the test procedure, a number of bytes of test data that will be transmitted and/or received during the test procedure, and/or an IP address range targeted by the test procedure. The network monitor 205 passes the received testing procedure information to the rule comparator 210, which determines which network(s) are affected by the requested test (block 604). For example, the rule comparator 210 may determine whether the requested test affects the first example packet-switched network 105, the second example packet-switched network 110, the example circuit-switched network 115, all available networks, and/or any combination thereof.

Based on which network(s) is/are affected, as determined by the rule comparator 210, the rule selector 215 generates an appropriate query to the data store 225 to extract all rules that are relevant to the potentially affected networks (block 606). For example, the rule comparator 210 may determine that only network #1 (e.g., the first example packet-switched network 105) is affected by the requested test procedure. As such, the rule selector 215 query will constrain a search of the data store 225 to only those rules that include an “Applies To” criterion of “Netw, #1” and/or “All Netwks.” As described above, one or more user/subscriber owned and/or operated packet-switched networks may be employed by the example system 100 of FIG. 1, such as the first example packet-switched network 105 and/or the second example packet-switched network 110. Persons of ordinary skill in the art will appreciate that the data store 225 query may operate in any number of ways. In the illustrated example process 504, the rule selector 215 retrieves all rules from the data store 225 that match the query conditions for “Netw. #1” (block 606) and stores those rules in a list of a memory in the rule selector 215. The rule comparator 210 determines if the rule is applicable by analyzing each rule from the stored list (block 608). If the rule comparator 210 has not evaluated all rules in the list, then the rule comparator 210 compares the rule constraint to the corresponding rule threshold (block 610) to determine if the rule logic is true and the specified results (e.g., “Allow” or “Deny”) of the requested test procedure should apply (block 612). If the logic permits the requested test procedure to execute (block 612), then control returns to block 608 to evaluate the next rule in the list, if any. However, if the logic does not result in authorization to execute the requested test procedure, then the test is prohibited from executing (block 614) and control returns to block 502 of FIG. 5. Returning to block 608, if the rule comparator 210 reaches the end of the rule list stored in the table of the rule selector 215 and none of the analyzed rules prohibits the requested test procedure from executing, then the requested test procedure is allowed to execute (block 616). Persons having ordinary skill in the art will appreciate that the logic of example blocks 608 through 612 may operate, without limitation, as a logical AND condition or a logical OR condition.

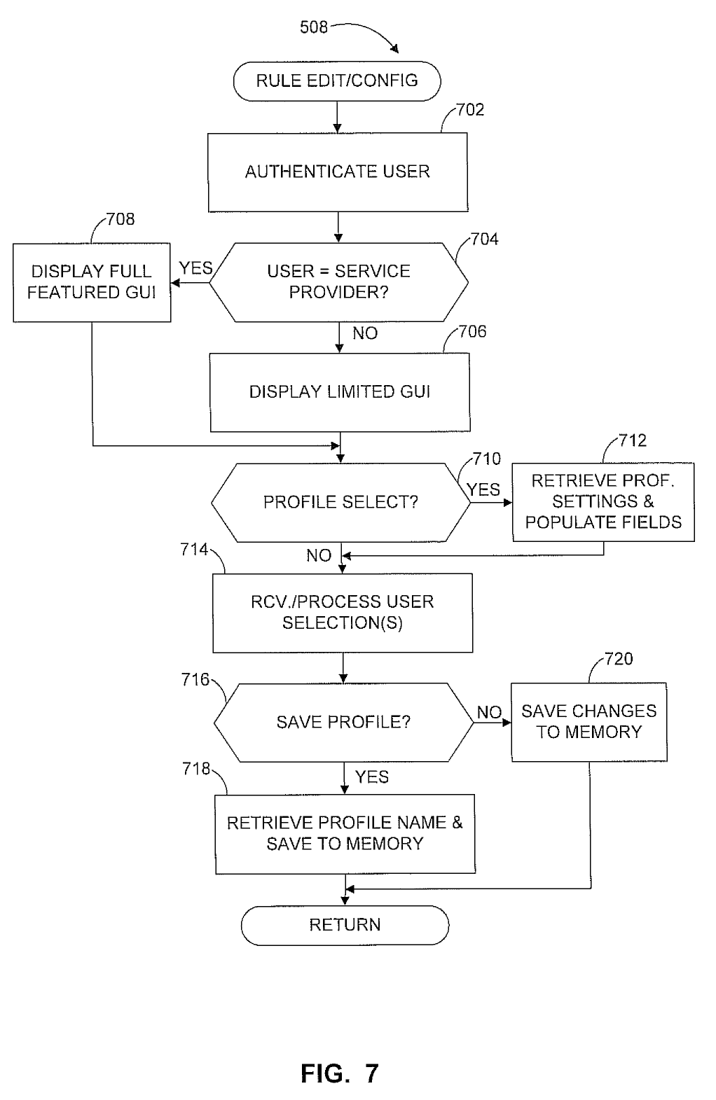

Returning to block 506 of FIG. 5, if the test rule portal 220 is accessed by a user, the example process 500 handles the user request (block 808), as shown in further detail in FIG. 7. In the illustrated example process of FIG. 7, the test rule portal 220 authenticates the user (block 702). Persons of ordinary skill in the art will appreciate that authentication, authorization, and/or encryption techniques may be employed by the test rule portal 220 to prevent unauthorized use and/or monitoring of the test rule manager 180. The test rule portal 220 determines whether the authorization credentials provided by the user correspond to a subscriber or a service provider (e.g., a network technician, a network engineer, a third party agent of the service provider, etc.) (block 704). If the authorization credentials correspond to a subscriber (block 704), then the test rule portal 220 provides the subscriber with a limited functionality GUI, such as the example GUI 400 discussed above in view of FIG. 4 (block 706). On the other hand, if the authorization credentials correspond to a service provider (block 704), then the test rule portal 220 provides the service provider with a full featured GUI, such as the example GUI 300 discussed above in view of FIG. 3 (block 708).

The test rule portal 220 determines if the user selects an existing profile from the “Load Profile” button 390, as shown in FIG. 3 (and shown as item 490 in FIG. 4) (block 710). If so, then the test rule portal 220 reads the selected profile name from the profile-name drop-down box 392 and retrieves such profile settings from the data store 225. The retrieved profile settings are populated on the example GUI 300 or GUI 400, depending on whether the user is a subscriber or a service provider (block 712). The test rule portal 220 receives any additions, deletions, and/or edits to the list of rules shown in the example GUI (300, 400) (block 714). If the user chooses to save the GUI (300, 400) as a new profile name (block 716), the test rule portal 220 retrieves the new profile name from the edit box 388 and saves the profile settings to memory, such as the example data store 225 shown in FIG. 2 (block 718). However, if the user chooses to make additions, deletions, and/or edits to the rules without generating a new profile name, then the example test rule portal 220 may save such changes as they are made to the example data store 225 (block 720).

Another example system 800 to manage network testing procedures is shown in FIG. 8. The example system 800 of FIG. 8 is substantially similar to the example system 100 of FIG. 1 and reference numbers of similar items will be shown in FIG. 8. Unlike the example system 100 of FIG. 1, the example system 800 of FIG. 8 does not include the test rule manager 180. Instead, any authorization to permit and/or prohibit execution of a test procedure is controlled by the VoIP-enabled phones, such as the first VoIP-enabled phone 130, and/or the second VoIP-enabled phone 135. Each of the VoIP-enabled phones (130, 135) includes a phone rule processor 802 to allow or prohibit a test from using the phone. As discussed in further detail below the phone rule processor 802 compares a test request against one or more rules to determine if the test should proceed based on, for example, current network bandwidth limitations, time of day constraints, and/or whether the example VoIP-enabled phone (e.g., 130 and/or 135) is making and/or receiving a call.

In operation, the example test control server 170 Facilitates device and/or NE testing by initiating test procedures to one or more devices and/or NEs. As described above, tests executed by the test control server 170 result in a finite bandwidth consumption between VoIP-enabled phones and the network(s) that accommodate communication therebetween. In the illustrated example system 800 of FIG. 8, the test control server 170 initiates a request to utilize the first VoIP-enabled phone 130 and the second VoIP-enabled phone 135 of the example first packet-switched network 105. Persons having ordinary skill in the art will appreciate that if the service provider also owns, maintains, and/or operates the second packet-switched network 110, then the test control server 170 may initiate one or more requests to utilize the third VoIP-enabled phone 140 for one or more test procedures. Upon the first VoIP-enabled phone 130 receiving the test request from the test control server 170, the phone rule processor 802 of the first VoIP-enabled phone 130 determines whether to permit or prohibit the test from executing. Similarly, upon the second VoIP-enabled phone 135 receiving the test request from the test control server 170, the phone rule processor 802 of the second VoIP-enabled phone 135 determines whether to permit or prohibit the test from executing.

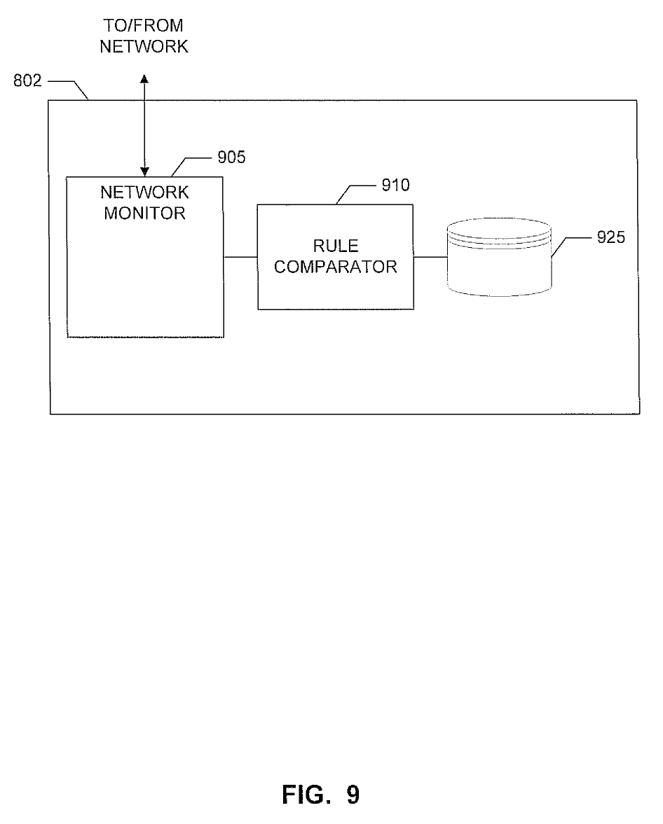

An example phone rule processor 802 is shown in FIG. 9. The example phone rule processor 802 includes a network monitor 905, a rule comparator 910, and a data source 925. In the illustrated example, the network monitor 905 is communicatively connected to a network, such as, for example, the first packet-switched network 105. The network monitor 905 monitors for test requests initiated by the test control server 170 and/or a call control server (e.g., the call control server 120 of the first packet-switched network 105).

Upon receipt of a test request, the network monitor 905 queries the rule comparator 910 and provides the rule comparator 910 with information relating to the test request. As discussed above, the test request may include information relating to, for example, the duration of the test, and/or the number of test iterations to be executed. The rule comparator 910 retrieves one or more rules from the data source 925 and compares the retrieved rule against the test request information. However, if the retrieved rule is a blanket denial of all tests, then the phone rule processor 802 will prohibit the test from using the VoIP-enabled phone (e.g., 130, 135).

To determine whether to permit and/or prohibit the test procedure, the phone rule processors 802 of the first and second VoIP-enabled phones (130, 135) compare the test request with rules stored in a memory (e.g., the data source 925) of the phone rule processor 802. For example, the first VoIP-enabled phone 130 may include a rule to deny all test requests, thereby prohibiting the execution of a test that employs the first VoIP-enabled phone 130. Alternatively, the first VoIP-enabled phone 130 may include a rule to allow all test requests of a first type, but prohibit test requests of a second type. The first type of test request may, for example, consume a relatively lower amount of network bandwidth than the second type of test request. Without limitation, the VoIP-enabled phones (130, 135) may include one or more rules to determine whether or not to allow a test procedure to use the phone. As discussed above in view of FIGS. 3 and 4, the rule(s) may consider the available network bandwidth, the date, the time of day, the test count limit, the IP range, and/or the duration of the test procedure.

A set of one or more rules may be stored on the VoIP-enabled phones (130, 135) as a profile. The profile and/or one or more rules may include a version identifier to allow the network administrator to determine if the VoIP-enabled phone (e.g., one or more of 130 and/or) has a current rule and/or profile stored thereon. Persons having ordinary skill in the art will appreciate that the rule(s) and/or profile(s) may be stored on the VoIP-enabled phones (130, 135) at the time of manufacture, prior to shipment to the user, and/or stored on the VoIP-enabled phones (130, 135) via remote access. As discussed in further detail below, the network/system administrator and/or the service provider may query one or more VoIP-enabled phones (130, 135) of the network(s) to determine whether there is a rule and/or profile stored thereon. If the one or more VoIP-enabled phones (130, 135) do not include one or more rules, a profile of rules, and/or the rule(s) are not current, then the service provider may upload the one or more rules and/or profile of rules to each VoIP-enabled phone (130, 135), as needed.

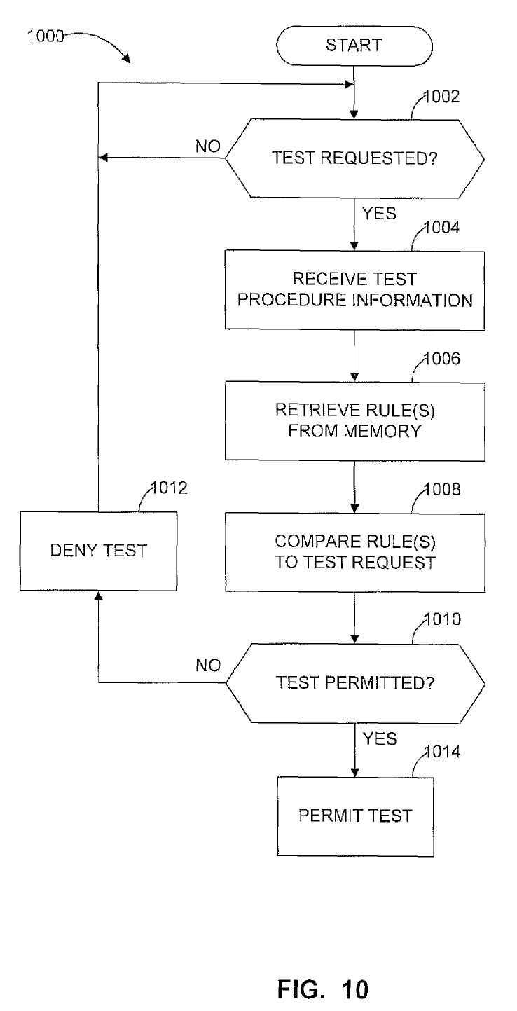

An example process 1000 of FIG. 10 begins at block 1002 where the VoIP-enabled phone (e.g., 130, 135) determines if the test control server 170 has issued a test request that employs the phone (block 1002). If not, then the VoIP-enabled phone (130, 135) continues to monitor for any such request while facilitating communication services to the user. However, if the VoIP-enabled phone (130, 135) detects a test request, the VoIP-enabled phone (130, 135) receives the test request from the test control server 170 (block 1004) and retrieves one or more rules from the memory of the VoIP-enabled phone (130, 135) (block 1006). For example, the test request submitted by the test control server 170 may include information indicative of the type of test that will be executed. The information may include, but is not limited to, the amount of bandwidth to be consumed by the test, the duration of the test, the number of test cycles, and/or the time(s) at which the test will execute. The VoIP-enabled phone (130, 135) compares the one or more rules and/or profile of rules to the information included in the test request (block 1008) to determine whether to permit or prohibit the test (block 1010). As described above, the rules may include various parameters and/or thresholds that are compared to the test request information. For example, if the VoIP-enabled phone (130, 135) includes a rule to deny all tests that operate for a duration exceeding 7-seconds, then any test request having a parameter indicating a duration over 7-seconds will be prohibited from executing. Test requests failing to comply with one or more rules of the VoIP-enabled phone (130, 135) are prohibited from executing (block 1012), otherwise the test is permitted (block 1014).

FIG, 11 is an example process 1100 of the VoIP-enabled phone (130, 135) during periods of use (e.g., sending or receiving a call) and during periods of inactivity. The example process 1100 begins at block 1102 where the example VoIP-enabled phone (130, 135) determines whether it is being used to send or receive a call. If the phone is not currently in use, the example VoIP-enabled phone (130, 135) determines whether a test request has been received (block 1104). If no test request has been received, such as a test request from the example test control server 170 of FIG. 8, then the phone continues to monitor for use (block 1102). On the other hand, if the VoIP-enabled phone (130, 135) receives a test request during this period of non-use, and such test request does not violate any of the one or more rules stored thereon, then the test is permitted to execute (block 1106). During execution of the test procedure, in which the VoIP-enabled phone (130, 135) is being employed, the phone monitors for any incoming calls and/or for any outgoing calls by the user (block 1108). If no such use is detected (block 1108) and the test is not complete (block 1110), then the test continues to execute (block 1106). However, if the example VoIP-enabled phone (130, 135) receives an incoming call, and/or if the user picks up the handset to place an outgoing call (block 1108), then the test is interrupted (block 1112) and possibly aborted. In the event that the example VoIP-enabled phone (130, 135) is in use (block 1102) and a test request is received (block 1114), then the test is prohibited from executing (block 1116).

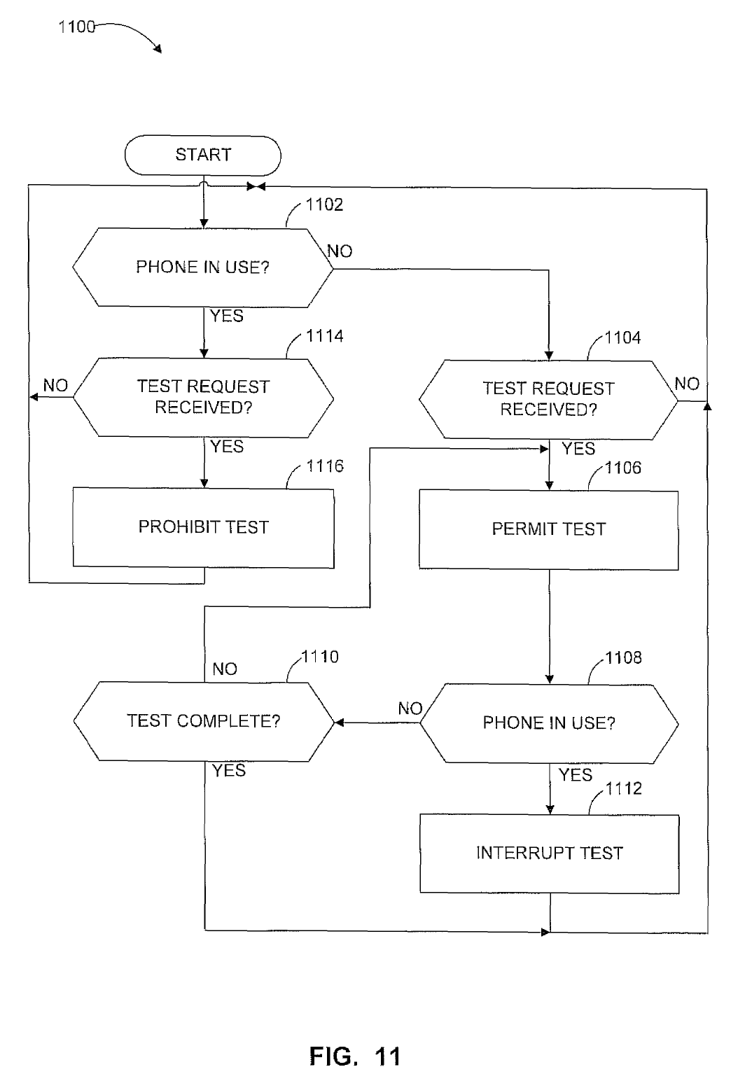

Persons having ordinary skill in the art will appreciate that the relationship between the user calls and any test calls is dynamic and asynchronous. Generally speaking, the example process 1000 of FIG. 10 and example process 1100 of FIG. 11 may operate as a finite state machine. The processes 1000 and 1100 may operate as a reactive system based on, for example, various states of the user's interaction with telephony equipment and/or the various states of the telephony equipment itself. For example, if the user is involved with a call (one particular state), then a transition of a test call request (one particular transition) results in a particular responsive event, such as a denial of the test request. Persons having ordinary skill in the art will also appreciate that example VoIP-enabled phone (130, 135) used in the present descriptions are only to illustrate more general notions of customer premises equipment (CPE) or customer terminal equipment (CTE), to which the present system applies. CPEs and/or CTEs may support multiple simultaneous calls, also referred to as multiple lines of capacity. Therefore, the above rules for a single line VoIP telephone may be generalized for multiple lines. For example, instead of judging if the phone is in use, the rule for a multi-line CPE may judge how much of the CPE is in use; the permission may be based on the probability of collision between user calls and tests; and the number of simultaneous test procedures in execution may be more than one.

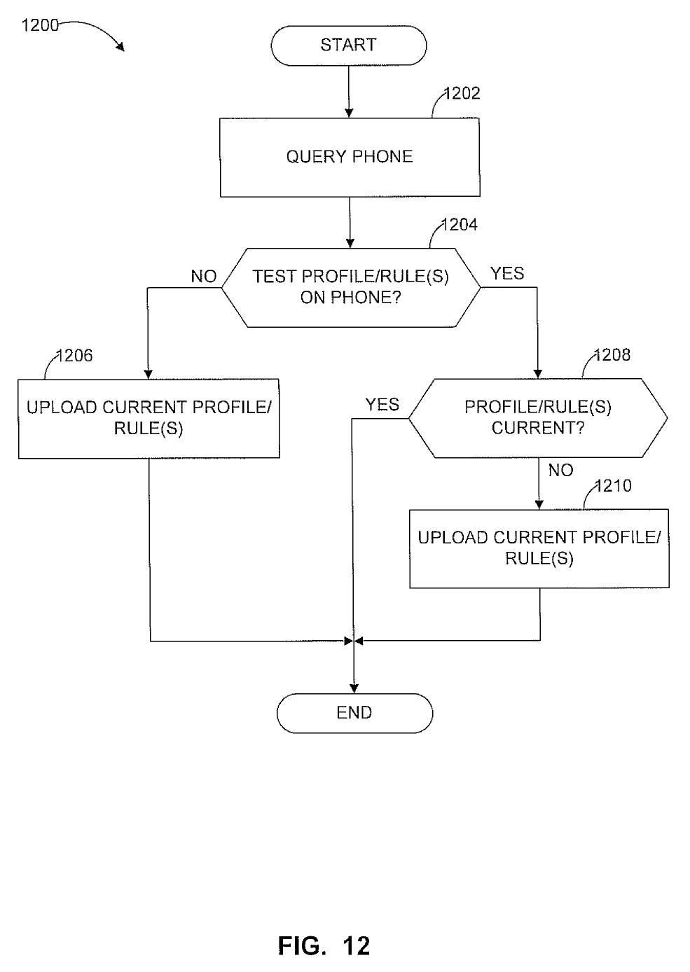

FIG. 12 is an example process 1200 of the VoIP-enabled phone (130, 135) to upload and/or update one or more rules and/or profiles of rules to the memory of the example VoIP-enabled phone (130, 135). The example process 1200 begins at block 1202 where a query is made to one or more of the example VoIP-enabled phones (130, 135). The query may originate from the service provider, from the system engineer, from the network technician, and/or from the example test control server 370 (block 1202). For example, the test control server 170 may query VoIP-enabled phones on a scheduled and/or periodic basis (block 1202) to verify whether the phones have one or more rules stored thereon. Alternatively or additionally, the test control server 170 may query the VoIP-enabled phones (130, 135) to verify whether the phones have the most current rules stored thereon (block 1202). If the example VoIP-enabled phone (130, 135) being queried does not have one or more rules stored in the memory (block 1204), then one or more rules, and/or a profile of rules is uploaded to the example VoIP-enabled phone (130, 135) (block 1206).

On the other hand, if the example VoIP-enabled phone (130, 135) being queries includes one or more rules stored in the memory (block 1204), then the example test control server 170 (and/or the service provider, the network engineer, and/or the network technician) determines whether the rule and/or profile version is current (block 1208). If not, then the example test control server 170 uploads one or more rules or a profile of rules to the example VoIP-enabled phone (130, 135) (block 1210). As a simpler alternative to downloading rules, rules governing test procedures may be factory-built into the CPE (e.g., VoIP telephone), for lower cost, higher reliability, and stronger security.

FIG. 13 is a block diagram of an example computer 1300 capable of executing the example machine recordable instructions represented by the flowcharts of FIGS. 5-7 and FIGS. 10-12 to implement the apparatus and methods disclosed herein. The computer 1300 can be, for example, a server, a personal computer, a laptop, a PDA, or any other type of computing device.

The computer 1300 of the instant example includes a processor 1310 such as a general purpose programmable processor. The processor 1310 includes a local memory 1311, and executes coded instructions 1313 present in the local memory 1311 and/or in another memory device. The processor 1310 may execute, among other things, the example processes illustrated in FIGS. 5-7 and FIGS. 10-12. The processor 1310 may be any type of processing unit, such as a microprocessor from the Intel® Centrino® family of microprocessors, the Intel® Pentium® family of microprocessors, the Intel® Itanium® family of microprocessors, the Intel XScale® family of processors, and/or the Motorola® family of processors. Of course, other processors from other families are also appropriate.

The processor 1310 is in communication with a main memory including a volatile memory 1312 and a non-volatile memory 1314 via a bus 1316. The volatile memory 1312 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1314 may be implemented by flash memory and/or any other desired type of memory device. Access to the main memory 1312, 1314 is typically controlled by a memory controller (not shown) in a conventional manner.

The computer 1300 also includes a conventional interface circuit 1318. The interface circuit 1318 maybe implemented by any type of well known interface standard, such as an Ethernet interface, a universal serial bus (USB), and/or a third generation input/output (3GIO) interface.

One or more input devices 1320 are connected to the interface circuit 1318. The input device(s) 1320 permit a user to enter data and commands into the processor 1310. The input device(s) can be implemented by, for example, a keyboard, a mouse, a touchscreen, a track-pad, a trackball, isopoint and/or a voice recognition system.

One or more output devices 1322 are also connected to the interface circuit 1318. The output devices 1322 can be implemented, for example, by display devices (e.g., a liquid crystal display, a cathode ray tube display (CRT), a printer and/or speakers). The interface circuit 1318, thus, typically includes a graphics driver card.

The interface circuit 1318 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 1300 also includes one or more mass storage devices 1326 for storing software and data. Examples of such mass storage devices 1326 include floppy disk drives, hard drive disks, compact disk drives and digital versatile disk (DVD) drives. The mass storage device 1326 may implement the memory of the example data store 225 and/or 925.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

To the extent the above specification describes example components and functions with reference to particular standards and protocols, it is understood that the scope of this patent is not limited to such standards and protocols. For instance, each of the standards for Internet and other packet switched network transmission (e.g., Transmission Control Protocol (TCP)/internet Protocol (IP), HyperText Markup Language (HTML), HyperText Transfer Protocol (HTTP)) represent examples of the current state of the art. Such standards are periodically superseded by faster or more efficient equivalents having the same general purpose. Accordingly, replacement standards and protocols having the same general purpose are equivalents to the standards/protocols mentioned herein, and contemplated by this patent, are intended to be included within the scope of the accompanying claims.

This patent contemplates examples wherein a device is associated with one or more machine readable mediums containing instructions, or receives and executes instructions from a propagated signal so that, for example, when connected to a network environment, the device can send or receive voice, video or data, and communicate over the network using the instructions. Such a device can be implemented by any electronic device that provides voice, video and/or data communication, such as a telephone, a cordless telephone, a mobile phone, a cellular telephone, a Personal Digital Assistant (PDA), a set-top box, a computer, and/or a server.

Additionally, although this patent discloses example software or firmware executed on hardware and/or stored in a memory, it should be noted that such software or firmware is merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example methods and articles of manufacture, persons of ordinary skill in the art will readily appreciate that the examples are not the only way to implement such methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to enable packet telephony performance testing comprising:
receiving a request to execute a test;
obtaining a testing rule associated with the requested test, the testing rule including a test parameter threshold;
determining a compliance status between the test parameter threshold and the request to execute the test; and
allowing or denying execution of the test based on the compliance status.

2. A method as defined in claim 1, wherein the test request specifies at least one of a test call duration, a test frequency, a media type, a codec type, a network element (NE), an internet protocol (IP) address, or a bandwidth consumption value.

3. A method as defined in claim 2, wherein the NE comprises at least one of a VoIP telephone, a circuit telephone, a circuit test responder, or a packet test responder.

4. A method as defined in claim 1, further comprising obtaining a network value representative of a network condition.

5. A method as defined in claim 4, wherein determining the compliance status comprises comparing the test parameter threshold against the network value.

6. A method as defined in claim 4, further comprising measuring a plurality of the network values and saving the plurality of the network values to a memory.

7. A method as defined in claim 6, wherein the plurality of network values comprise at least one of packet delay, jitter, packet loss, or call completion success.

8. A method as defined in claim 1, wherein the test parameter threshold corresponds to at least one of an existing call preservation status, a media bandwidth threshold, an available bandwidth threshold, an existing call quality threshold, a test call security status, a test time duration threshold, a test denial flag, a test permission flag, or a test frequency threshold.

9. (canceled)

10. A method as defined in claim 8, wherein the test call security status is approved if the test is executed by an authenticated VoIP telephone.

11. A method as defined in claim 8, wherein the existing call quality threshold comprises at least one of a network jitter threshold, a network packet-loss threshold, an eye-diagram mask threshold, or a network bit-rate threshold.

12. A method as defined in claim 11, further comprising obtaining a network value representative of a network condition.

13. A method as defined in claim 12, wherein if the network value exceeds at least one of the network jitter threshold, the network packet-loss threshold, the eye-diagram mask threshold, or the network bit-rate threshold, execution of the test is denied.

14. A method as defined in claim 12, wherein the network value is an authorization status of a network element, and the execution of the test is permitted if the network value does not violate the test call security status.

15. A method as defined in claim 12, wherein the network value is a bandwidth value, and the execution of the test is permitted if the network value does not exceed the available bandwidth threshold.

16-18. (canceled)

19. A method as defined in claim 1, wherein the testing rule is configured by a subscriber.

20-21. (canceled)

22. A method as defined in claim 1, wherein a test ride manager receives the request to execute the test.

23. A network testing apparatus comprising:
a test control server to control a network testing procedure on a network;
a call control server communicatively coupled to the test control server, the call control server to control at least one communication endpoint on the at least one network; and
a test rule manager communicatively coupled to the test control server to permit or block the network testing procedure based on a current network condition.

24. A network testing apparatus as defined in claim 23 wherein the test rule manager comprises:
a memory to store a testing rule;
a rule selector to retrieve the testing rule from the memory; and
a rule comparator to compare the testing rule with the current network condition.

25. A network testing apparatus as defined in claim 24, wherein the testing rule specifies at least one of an available bandwidth, a current call quantity, a date range, a time range, an internet protocol (IP) address range, or a test duration.

26. (canceled)

27. An article of manufacture storing machine readable instructions which, when executed, cause a machine to:
receive a test request to execute a test;
obtain a testing rule associated with the requested test, the testing rule including a test parameter threshold;
determine a compliance status between the test parameter threshold and the request to execute the test; and
allow or deny execution of the test based on the compliance status.

28. An article of manufacture as defined in claim 27, wherein the machine readable instructions further cause the machine to analyze at least one of a test call duration, a test frequency, a media type, a codec type, a network element (NE), an internet protocol (IP) address, or a bandwidth consumption value.

29-47. (canceled)

48. A network testing apparatus comprising:
a test control server to initiate a network testing procedure on a network;
a telephone rule processor to receive a test request from the test control server; and
a rule comparator to compare the received test request to at least one rule to at least one of allow the test or prohibit the test.

49. A network testing apparatus as defined in claim 48, wherein the telephone rule processor comprises a memory to store the at least one rule.

50. A network testing apparatus as defined in claim 48, wherein the at least one rule specifies at least one of a minimum available bandwidth, a date rate, a time range, or a test duration.
